(19) United States
(12) Patent Application Publication
(10) Pub. No.: US 2025/0128191 A1
(43) Pub. Date: Apr. 24, 2025

(54) Filter Device

(71) Applicant: HYDAC Process Technology GmbH, Neunkirchen (DE)

(72) Inventors: Hans-Jürgen Lingen, Münchengladbach (DE); Raphael Klein, Netphen (DE); Sebastian Hrin, Elsdorf (DE)

(73) Assignee: HYDAC Process Technology GmbH, Neunkirchen (DE)

(21) Appl. No.: 18/689,164

(22) PCT Filed: Aug. 1, 2022
(86) PCT No.: PCT/EP2022/071559

§ 371 Date: Mar. 5, 2024

(30) Foreign Application Priority Data
Sep. 13, 2021 (DE) 10 2021 004 616.1

(51) Int. Cl. B01D 29/66; B01D 35/16

(52) U.S. Cl. CPC B01D 29/668; B01D 35/16; B01D 2201/583

(57) ABSTRACT

A filter device is disclosed comprising a filter which is used to clean a fluid flow of particulate contamination in a specifiable flow direction, having a fluid inlet for supplying an unfiltered medium flow, a fluid outlet for removing a filtrate flow, and a discharge opening for discharging a backflushing fluid produced while backflushing the filter against the specifiable flow direction using a backflushing device, wherein as the particulate contamination being cleaned out of the fluid flow by the filter increases, the differential pressure between the fluid inlet and the fluid outlet increases, characterised in that a valve device is arranged downstream of the discharge opening, viewed in the fluid flow direction, said valve device regulating the discharge rate of backflushing fluid as a function of the differential pressure.

### CROSS-REFERENCE TO RELATED APPLICATIONS

This application claims priority to German Patent Application No. DE 10 2021 004 616.1, filed on Sep. 13, 2021 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a filter device comprising a filter which is used to clean a fluid flow of particulate contamination in a specifiable flow direction, having a fluid inlet for supplying an unfiltered medium flow, a fluid outlet for removing a filtrate flow, and a discharge opening for discharging a backflushing fluid produced while backflushing the filter against the specifiable flow direction using a backflushing device, wherein, as the particulate contamination being cleaned out of the fluid flow by the filter increases, the pressure difference between the fluid inlet and the fluid outlet increases.

DE 10 2017 001 968 A1 discloses a generic filter device which is used for filtering lubricating oil, in particular. This filter device consists of at least two filter inserts of a filter in which a filter material is received in each case, said inserts being furnished with fluid passage points and being able to be stacked on top of one another forming a composite stack, wherein a backflushing device is provided, having a flushing arm which, arranged such that it can be displaced along the inside of the filter inserts with its individual chamber-like slotted nozzles, carries out a cleaning operation of the particulate contamination deposited there during filtration in that the backflushing fluid, which originates from the filtrate side of the device, passes in the opposite flow direction to during filtration via a discharge opening which is connected to the flushing arm out of the filter device onto the dirty or sludge discharge side.

It is very important that the lubricating oil should be in perfect condition to ensure operational safety and maintain the service life of combustion engines. In particular, continuous operation of diesel engines, which may, for example, be operated with heavy fuel oil in maritime applications, poses particularly high demands on the quality of the lubricating oil, which means that the use of filter devices as specified above is essential in such applications to clean the lubricating oil. The backflushing devices used in this respect are often designed as so-called continuous flushers, which means that the filter device does not have a corresponding sludge discharge valve in the backflushing line on the dirty or sludge discharge side, with the result that backflushing volumes are continuously discharged from the filter device, said volumes consisting of the backflushing fluid originating from the filtrate side which also conveys the particulate contamination. Due to the backflushing volumes that are discharged continuously, the corresponding mode of operation requires an increased pump capacity, which in turn is linked to a higher energy consumption by the motors, which move the cleaning units in the form of slotted nozzles along the inside of the filter by means of backflushing arms. Backflushing filters operated by external energy are not acceptable in the market due to the independently operating filters in this respect, as said filters require independent monitoring effort.

### SUMMARY

A need exists to provide a filter device wherein the volume of backflushing fluid can be reduced in an energy-efficient manner and, for example, within a specifiable scope.

The need is addressed by the subject matter of the independent claim(s). Embodiments of the invention are described in the dependent claims, the following description, and the drawings.

### BRIEF DESCRIPTION OF THE DRAWINGS

FIG. 1 shows the components of an example filter device in the form of a hydraulic circuit diagram;

FIGS. 2 to 4 show a valve device associated with the hydraulic circuit diagram according to FIG. 1 in the form of a pressure compensator;

FIG. 5 shows a modified embodiment of the hydraulic drive and backflushing solution according to FIG. 1 with a modified valve device designed as a pressure compensator;

FIGS. 6 to 8 show the modified valve device according to FIG. 5 in various actuation or control positions; and

FIG. 9 is an example circuit diagram representation corresponding to FIG. 1 but in the electrical configuration with an electric drive motor for the backflushing device of the filter and an electromagnetically controlled valve device.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

By virtue of the fact that, according to some embodiments, viewed in the fluid flow direction, a valve device is arranged downstream of the discharge opening, said valve device regulating the discharge rate of backflushing fluid as a function of the differential pressure, the valve device forms a kind of pressure compensator which regulates the cross-section of the backflushing line downstream of the discharge opening as a function of the differential pressure in relation to the fluid inlet and the fluid outlet, such that, as contamination of the filter increases, the pressure compensator increasingly releases the necessary cross-section to backflush or effectively clean, respectively, the filter element until a maximum possible opening position is reached. The backflushing volume that can be specified by means of the pressure compensator in this process is proportional to the opening cross section of the valve device and regulates to a minimum required backflushing energy to clean the filter, which is extremely energy-efficient, and relieves the drive motors for actuating the backflushing device, irrespective of whether these are driven by hydraulic or electrical means, thus extending their service life.

In some embodiments, it is provided that, as the filter becomes increasingly contaminated and the differential pressure increases as a result, the valve device increasingly passes into its fully open position in which backflushing becomes more intensive. This leads to there being no backflushing at the inlet and outlet due to the balanced pressure ratio, wherein normal backflushing takes place by means of continuous intermediate steps in which the filter is initially slightly contaminated, until extremely unbalanced pressure ratios are achieved between the inlet and the outlet, which can be equated to considerable contamination of the filter with the result that more intensive backflushing takes place, simultaneously increasing the drive output for the drive motor of the backflushing device used in each case.

In some embodiments, it is provided that the valve device is formed by a proportional valve which is hydraulically or electrically actuated and controlled by the differential pressure at the filter. As such, the filter device can readily be adapted to the energy source available on site in each case by hydraulic/electrical means across a wide range of applications without having to adapt the design of the key components, in particular in the form of the valve device or pressure compensator.

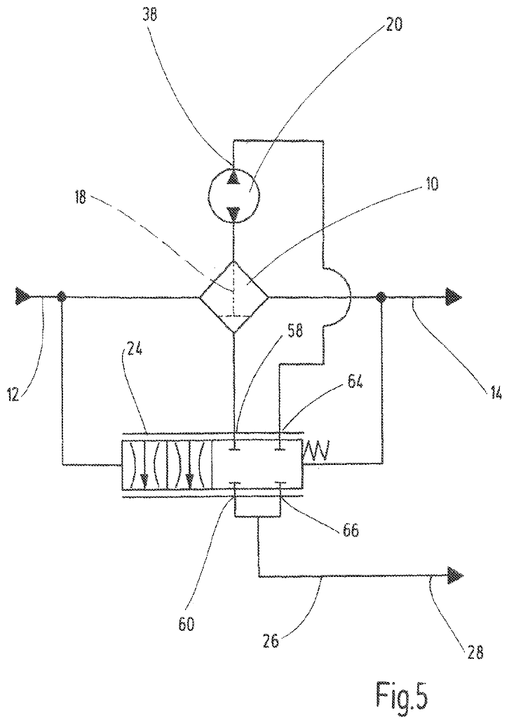

In the case of a hydraulic drive solution, it is provided that the backflushing device has a drive motor, which is integrated in the regulation system with the valve device such that, as the differential pressure at the filter increases and the valve device opens increasingly, the drive motor is controlled in the direction of higher speeds for increased backflushing. More beneficially, if a hydraulic drive motor is used in embodiments according to FIG. 5, the fluid transport/discharge on the outlet side of this motor is controlled by the valve device or the pressure compensator respectively, which is easier to accomplish from a control technology point of view than regulating the inlet for the hydraulically actuatable drive motor. As such, a self-regulating system is created and the service life of the filter, which often takes the form of a filter basket, is extended alongside the hydraulic drive.

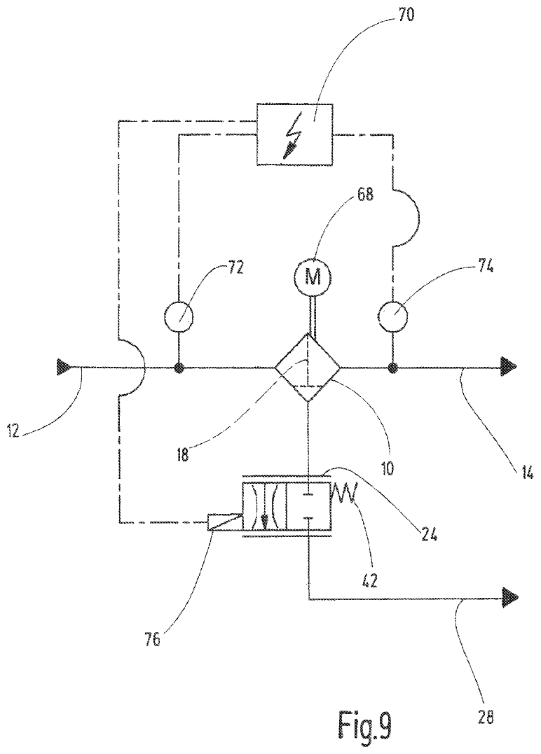

In embodiments according to FIG. 9, it is provided that, with an electric drive motor, the differential pressure between the fluid inlet and the fluid outlet is determined by pressure sensors, which transmit their measured pressure values to a regulation system, which controls the valve device and the drive motor by electrical means. While, in the hydraulic solution, there is in principle no need for differential pressure monitoring by means of pressure sensors and an electronic control system, this does, however, need to be provided for an electrical solution but this can be accommodated on the filter device in a space-saving manner in this respect.

In some embodiments, it is provided that the proportional valves used for the valve device, which are constructed in the manner of a pressure compensator, are 2/2-way or 4/2-way proportional valves. While, when using a 2/2-way proportional valve, discharge rate regulation primarily takes place for the backflushing fluid, if the pressure compensator is configured as a 4/2-way proportional valve with a valve design, the hydraulic motor can also simultaneously be controlled as a drive source for the backflushing device, which allows the individual control operations to take place in a synchronous time sequence, thus avoiding incorrect actuation operations.

In some embodiments, it is provided that the hydraulically controlled valve device comprises a valve housing, in which a valve piston is guided in a longitudinally displaceable manner, having at least one opening in each case on opposite end faces of the valve housing for the purpose of connecting the valve device to the fluid inlet and outlet via control lines and having at least one recess, particularly in the form of an annular recess, in the valve piston for controlling a fluid connection between an inlet and an outlet in the valve housing, wherein the inlet is connected to the discharge opening of the filter and the outlet leads to a sludge discharge side. As such, the differential pressure to control the valve piston can be transmitted to said piston in a space-saving manner and, at the same time, at least the backflushing volume of the filter is regulated during discharge thereof by a valve piston. A highly dynamic regulation concept is also achieved in this manner.

In a beneficial manner, in this case it is also provided that the hydraulically controlled pressure compensator in the valve piston comprises a further recess, for example a further annular recess, for controlling a further fluid connection between a further inlet and a further outlet, wherein the further inlet is connected to the outlet side of the hydraulic drive motor for fluid discharge therefrom and the further outlet is connected to an outlet on the valve housing for controlling the backflushing discharge rate. As a result, the hydraulic drive for the backflushing device can also be controlled synchronously via the further recess in the valve piston as a function of the backflushing volume accruing in each case.

Particularly in connection with the discontinuous backflushing sought here for filtering lubricating oil, the filter device can be operated as described above without the need to fit an additional sludge discharge valve as a shut-off valve on the sludge discharge side, thus improving failsafe operation for the entire hydraulic system with the filter device.

The solution according to the invention is explained in greater detail below with reference to embodiments according to the drawings, which are in outline and not to scale.

Specific references to components, process steps, and other elements are not intended to be limiting. Further, it is understood that like parts bear the same or similar reference numerals when referring to alternate FIGS.

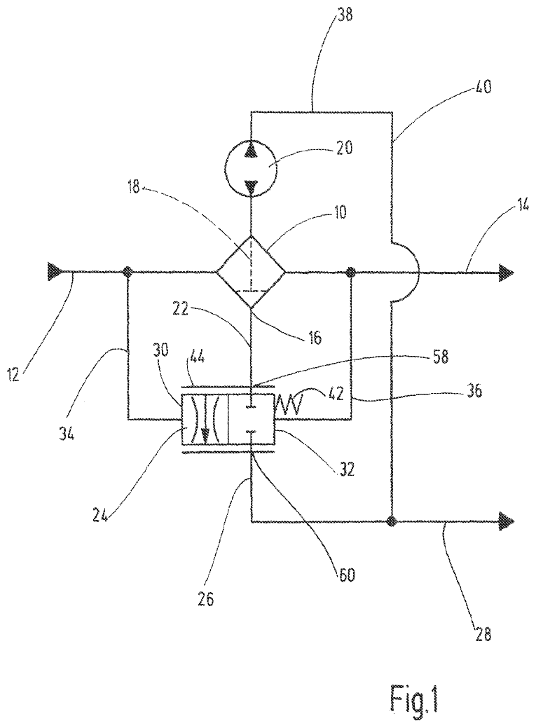

FIG. 1 shows the filter device in the form of a hydraulic circuit diagram in its entirety with a filter 10, which is used to clean a fluid flow, in the form of hydraulic oil or lubricating oil for example, of particulate contamination in a specifiable filter or flow direction. The filter device comprises a fluid inlet 12 for supplying an unfiltered medium flow and a fluid outlet 14 for removing a filtrate flow after cleaning the unfiltered medium flow via the filter 10. Furthermore, the filter 10 has on its base a discharge opening 16 for discharging a backflushing fluid produced while backflushing the filter 10 against the specifiable flow direction using a backflushing device 18. The corresponding structural design of a backflushing filter is disclosed in detail in DE 10 2017 001 968 A1, for example, which means that no further details of said design are provided at this juncture. In particular, the backflushing device 18 in FIG. 1 Is only reproduced symbolically and includes a flushing arm with its cleaning units in the form of slotted nozzles, said cleaning units being displaced along the inside of the filter 10, usually designed in the manner of a filter basket. A hydraulic drive 20 in the form of a hydraulic motor, which is supplied indirectly with filtrate via the inlet on the fluid outlet 14, is used to drive the flushing arm in rotation.

As is also shown on FIG. 1, viewed in a fluid flow direction, downstream of the discharge opening 16, a valve device 24 is connected in an associated connecting line, which acts as an inlet 22, said valve device being connected on its outlet side as an outlet 26 to a further fluid line which leads to a dirty or sludge discharge side 28. The corresponding sludge discharge 28 passes out of the filter device according to FIG. 1 and usually consists backflushing fluid with of the accruing the particulate contamination that can be discharged from the filter 10 during backflushing by means of the backflushing device 18. Furthermore, the valve device 24, which is designed in the manner of a pressure compensator, is connected on its opposite end faces 30, 32, and via an assigned control line 34, 36, to the fluid inlet 12 or the fluid outlet 14 in a permanent fluid-conveying manner, viewed in the flow direction before and after the filter 10.

The hydraulic drive 20 or the hydraulic motor respectively is supplied with filtrate on the filter side on its inlet side and is connected on its outlet side 38 via a fluid line 40 to the outlet 26 between the valve device 24 and the sludge discharge 28. In the solution according to FIG. 1, the hydraulic motor 20 and thus also the flushing device 18 are permanently driven; however, the backflushing process is controlled by means of the valve device 24 and is also interrupted if necessary.

The valve device 24 is designed in the manner of a pressure compensator in the form of a 2/2-way proportional valve and, viewed as seen on FIG. 1, is also and permanently loaded by an energy accumulator in the form of a compression spring 42 on the right-hand control side 32.

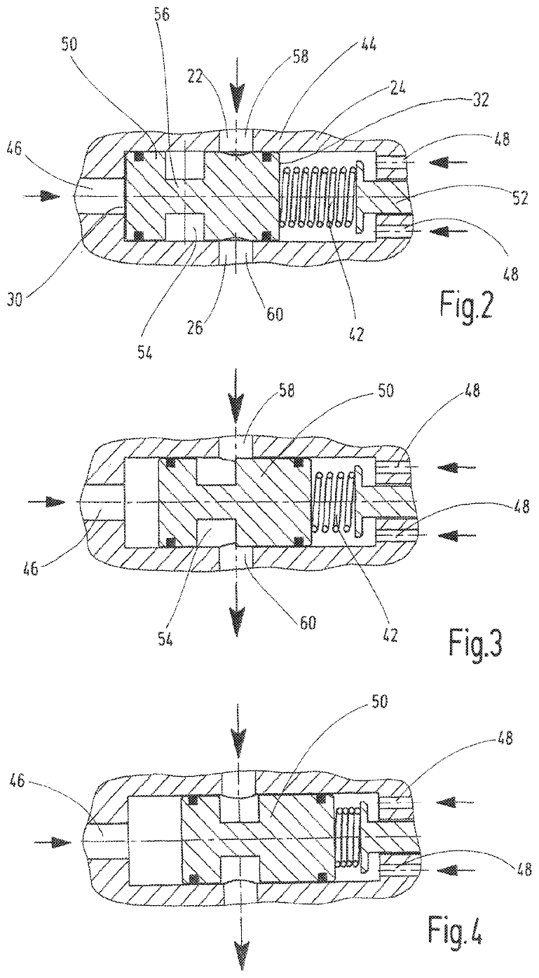

As the particulate contamination cleaned from the fluid flow by the filter 10 increases, the differential pressure between the fluid inlet 12 and the fluid outlet 14 increases, with the result that, due to the higher pressure at the fluid inlet 12, the valve device 24 is controlled against the action of the compression spring 62 and, in this process, the backflushing fluid discharge rate is increased. Accordingly, the potential backflushing fluid discharge rate from the filter 10 is therefore regulated as a function of the differential pressure, which is explained in further detail below with the aid of FIGS. 2 to 4.

Thus, the valve device 24 comprises a valve housing 44, only extracts of said housing being reproduced in FIGS. 2 to 4. The valve housing 44 comprises, on its left-hand side, viewed as seen on FIG. 2, a port 46 for the control line 34, and, on the opposite side, two further ports 48 are accommodated in the valve housing 44, said ports being connected together to the right-hand control line 36. Inside the multi-part (not shown) valve housing 44, a valve piston 50 is guided such that it can be displaced longitudinally, said valve piston being furnished, on its circumference, in the direction of its two control sides 30, 32, with one annular seal in each case. In this process, the right-hand control side 32 is supported on the compression spring 42, which, with its other free end, is supported on a support device 52 arranged in a stationary manner in the valve housing 44, one free end of the compression spring 42 being in permanent contact with a plate-shaped counter bearing of the support device 52.

Furthermore, the valve piston 50 comprises a recess 54, in the form of an annular recess, which passes completely through the circumference of the valve piston 50 and, in this process, basically subdivides the valve piston 50 into two control regions, which are integrally connected to one another by means of a pin-like central connection 56. Viewed as seen in FIG. 2, the valve housing 44 also comprises on its upper side a connection opening 58, which is connected to the inlet 22, which is in turn connected in a fluid-conveying manner to the discharge opening 16 of the filter 10. A further connection opening 60 is attached in the same plane and on the opposite side of the valve housing 44, said opening leading to the sludge discharge 28 via the outlet 26. The arrows shown in FIGS. 2 to 4 reproduce the possible fluid flow direction in each case.

In the displacement position of the valve piston as shown according to FIG. 2, the pressure at the fluid inlet 12 substantially corresponds to the pressure at the fluid outlet 14, i.e. the pressure prevailing in the port 46 corresponds to the pressure at the further two ports 48. Accordingly, the valve piston 50, in its left stop position, is held under the action of the compression spring 42 and the two connection openings 58, 60 are separated from one another by the valve piston 50, i.e. no fluid passes from the opening 58 to the opening 60 and thus to the sludge discharge 28. Due to the aforementioned balanced pressure ratio, the valve device 24 is accordingly in its closed position, as shown in FIG. 2, such that no backflushing takes place, because there is also no relevant contamination on the filter 10 in this respect. In this process, the hydraulic motor 20 and the flushing device 18 are permanently driven, only the backflushing process itself is interrupted by means of the valve device 24.

In the embodiment shown on FIG. 3, the pressure ratio from the inlet 46 to the outlet 48 is slightly unbalanced, so that the valve piston 50, viewed as seen on FIG. 3, moves to the right against the action of the compression spring 42, with the result that the valve device 24 opens slightly, increasingly creating the fluid connection between the connection openings 58 and 60 via the recess 54 such that not only the sludge discharge 28 is supplied with fluid. The corresponding cleaning situation can be equated to a small amount of contamination on the filter 10.

On the other hand, in the embodiment shown on FIG. 4, the pressure ratio between the port 46 and the further ports 48 is very highly unbalanced, with the result that the valve device 24 passes into its completely open position such that the hydraulic drive 20 is brought to maximum speed, resulting in intensive backflushing via the backflushing device 18, so that it can be assumed that, with the corresponding pressure ratio situation, a high level of contamination can be expected on the filter 10 before cleaning.

The backflushing filter illustrated in FIGS. 1 to 4 with a hydraulic pressure compensator in the backflushing line in the direction of the sludge discharge 28 thus acts as a hydraulically controlled 2/2-way proportional valve and regulates the backflushing volume as a function of the particulate contamination accruing on the filter 10. The unregulated hydraulic drive 20 is thus permanently driven.

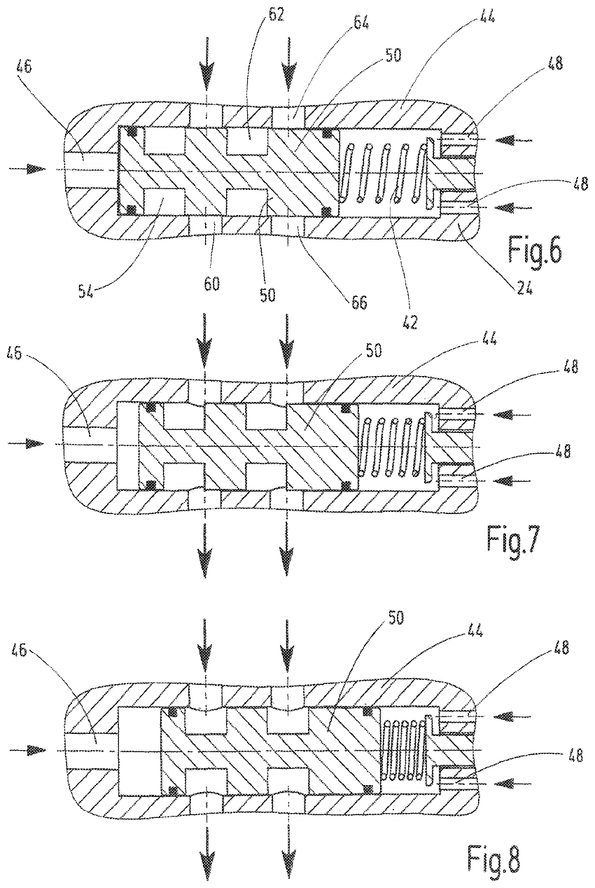

In the embodiment shown in FIGS. 5 to 8, improved regulation of the hydraulic drive takes place because a hydraulically controlled 4/2-way proportional valve is used as the valve device 24. In this manner, the correspondingly designed pressure compensator not only allows the backflushing volume to be regulated as described above, but also permits regulation of the hydraulic motor in the form of the drive 20. In FIGS. 5 and 6, the valve device 24 is in this case shown in its closed position, i.e. the pressure ratio between the fluid inlet 12 and the fluid outlet 14 is balanced, with the result that, as described above, the valve 24 is closed and backflushing does not take place. In the embodiment shown in FIG. 5, the hydraulic motor 20 and, connected thereto, the flushing device 18 are driven again or the backflushing process is driven again when the valve device 24 releases the associated flow cross-section. As a rule, the hydraulic motor 20 is thus always flushed with clean fluid or filtrate respectively from the filter 10. The corresponding situation is equated to there being no contamination on the filter element 10. For separate control of the hydraulic drive 20, the valve piston 50 comprises a further annular recess 62 as shown in FIGS. 6 to 8, particularly in the form of a further annular recess which is comparable with the first recess 54. In this case, the further recess 62 is arranged in the valve piston 50 between the first recess 54 and the right-hand control side 32. In order to control a further fluid connection by means of this recess 62, a further inlet 64 and a further outlet 66 are accommodated in the valve housing 44, the further inlet 64 being connected to the outlet side 38 of the hydraulic drive motor and the further outlet 66 being permanently connected to one outlet 60 on the valve housing 44 for controlling the backwashing discharge rate, which, together, lead via the outlet 26 in the direction of the sludge discharge 28.

If, according to the valve shown on FIG. 7, a slightly unbalanced pressure ratio arises between the port 46 and the further two ports 48, the valve device 24 opens partially and a normal backflushing operation takes place in which there is a normal flow in the direction of the hydraulic motor 20 in order to drive said motor. Accordingly, the contamination on the filter 10 can be classified as low.

If the contamination on the filter 10 is high, the pressure ratio between the inlet and the outlet 46, 48 is very unbalanced and the valve device 24 opens fully as shown in FIG. 8, which then leads to intensive backflushing in that the hydraulic motor 20 experiences it full drive speed in relation to the high flow and, accordingly, the backflushing device 18 is driven with a high rotation speed on the inside of the filter 10 for backflushing with the flushing arm.

In the embodiment shown in FIG. 9, the drive motor is an electric motor 68, which is controlled by a central control or regulation system 70. Said control or regulation system receives, as input signals via two pressure sensors 72, 74, information regarding the pressure at the fluid inlet 12 or fluid outlet 14. As the contamination level of the filter 10 increases and the differential pressure at the measurement points 72, 74 before or after the filter 10 respectively increases accordingly, the electric motor 68 is operated at a higher speed and thus actuates the backflushing device 18 to a greater extent. The associated higher backflushing volume is then passed in the direction of the sludge discharge 28 by actuating the valve device 24, an electromagnetic actuating device 76, as part of the valve control system, being electrically actuated by the regulation system 70 for this purpose. Otherwise, the embodiment according to FIG. 9 corresponds to FIG. 1 apart from the electrical design of the hydraulic embodiment. As such, there is thus likewise only one hydraulic control system for the backflushing volume and the drive motor for the device 18 is designed in electrical respects as described above.

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A filter device comprising a filter which is used to clean a fluid flow of particulate contamination in a specifiable flow direction, having a fluid inlet for supplying an unfiltered medium flow, a fluid outlet for removing a filtrate flow, and a discharge opening for discharging a backflushing fluid produced while backflushing the filter against the specifiable flow direction using a backflushing device;
wherein, as the particulate contamination being cleaned out of the fluid flow by the filter increases, the pressure difference between the fluid inlet and the fluid outlet increases; and
wherein a valve device is arranged downstream of the discharge opening in the fluid flow direction, said valve device regulating the discharge rate of backflushing fluid as a function of the differential pressure.

12. The filter device of claim 11, wherein, as the filter becomes increasingly contaminated and the differential pressure increases as a result, the valve device rapidly passes into its fully open position in which backflushing becomes more intensive.

13. The filter device of claim 11, wherein the valve device is formed by a proportional valve which is hydraulically or electrically actuated and controlled by the differential pressure at the filter.

14. The filter device of claim 11, wherein the backflushing device has a drive motor, which is integrated in the regulation system with the valve device such that, as the differential pressure at the filter increases and the valve device opens increasingly, the drive motor is controlled in the direction of higher speeds for increased backflushing.

15. The filter device of claim 11, wherein, with a hydraulic drive motor, the fluid is supplied on the inlet side of the drive motor with filtrate from the filter.

16. The filter device of claim 11, wherein, with an electric drive motor, the differential pressure between the fluid inlet and the fluid outlet is determined by pressure sensors, which transmit their measured pressure values to a regulation system, which controls the valve device and the drive motor by electrical means.

17. The filter device of claim 11, wherein the proportional valves used for the valve device, which are constructed in the manner of a pressure compensator, are 2/2-way or 4/2-way proportional valves.

18. The filter device of claim 11, wherein the hydraulically controlled valve device comprises a valve housing, in which a valve piston is guided in a longitudinally displaceable manner, having at least one opening in each case on opposite end faces of the valve housing for the purpose of connecting the valve device to the fluid inlet and outlet via control lines and having at least one recess, in particular in the form of an annular recess, in the valve piston for controlling a fluid connection between an inlet and an outlet in the valve housing, wherein the inlet is connected to the discharge opening and the outlet leads to a sludge discharge side.

19. The filter device of claim 11, wherein the hydraulically controlled pressure compensator in the valve piston comprises a further recess, in particular a further annular recess, for controlling a further fluid connection between a further inlet and a further outlet, wherein the further inlet is connected to the outlet side of the hydraulic drive motor and the further outlet is connected to one outlet on the valve housing for controlling the backflushing discharge rate.

20. The filter device of claim 11, wherein there is no need to attach an additional sludge discharge valve on the sludge discharge side.

21. The filter device of claim 12, wherein the valve device is formed by a proportional valve which is hydraulically or electrically actuated and controlled by the differential pressure at the filter.

22. The filter device of claim 12, wherein the backflushing device has a drive motor, which is integrated in the regulation system with the valve device such that, as the differential pressure at the filter increases and the valve device opens increasingly, the drive motor is controlled in the direction of higher speeds for increased backflushing.

23. The filter device of claim 13, wherein the backflushing device has a drive motor, which is integrated in the regulation system with the valve device such that, as the differential pressure at the filter increases and the valve device opens increasingly, the drive motor is controlled in the direction of higher speeds for increased backflushing.

24. The filter device of claim 12, wherein, with a hydraulic drive motor, the fluid is supplied on the inlet side of the drive motor with filtrate from the filter.

25. The filter device of claim 13, wherein, with a hydraulic drive motor, the fluid is supplied on the inlet side of the drive motor with filtrate from the filter.

26. The filter device of claim 14, wherein, with a hydraulic drive motor, the fluid is supplied on the inlet side of the drive motor with filtrate from the filter.

27. The filter device of claim 12, wherein, with an electric drive motor, the differential pressure between the fluid inlet and the fluid outlet is determined by pressure sensors, which transmit their measured pressure values to a regulation system, which controls the valve device and the drive motor by electrical means.

28. The filter device of claim 13, wherein, with an electric drive motor, the differential pressure between the fluid inlet and the fluid outlet is determined by pressure sensors, which transmit their measured pressure values to a regulation system, which controls the valve device and the drive motor by electrical means.

29. The filter device of claim 14, wherein, with an electric drive motor, the differential pressure between the fluid inlet and the fluid outlet is determined by pressure sensors, which transmit their measured pressure values to a regulation system, which controls the valve device and the drive motor by electrical means.

30. The filter device of claim 15, wherein, with an electric drive motor, the differential pressure between the fluid inlet and the fluid outlet is determined by pressure sensors, which transmit their measured pressure values to a regulation system, which controls the valve device and the drive motor by electrical means.
